(19) United States
(12) Patent Application Publication
(10) Pub. No.: US 2005/0268551 A1
(43) Pub. Date: Dec. 8, 2005

(54) Self-watering breeding device

(76) Inventor: Wen-Chi Lai, Feng Yuan City (TW)

Correspondence Address: HERSHKOVITZ & ASSOCIATES, 1725 I STREET NW, SUITE 300, WASHINGTON, DC, 20006, US

(21) Appl. No.: 10/862,391

(22) Filed: Jun. 8, 2004

(51) Int. Cl. A01G 27/04

(52) U.S. Cl. 47/81

(57) ABSTRACT

A self-watering breeding device has a culturing slide (10), a capillary sheet (20), and an optional immersion sheet (22). The culturing slide (10) has a gradual slop (11), a steep slop (12) and a guiding arc (122) connected between the gradual slop (11) and the steep slop (12). The capillary sheet (20) attaches on the steep slop (12) and extends over the guiding arc (122). The immersion sheet (22) attaches on the gradual slop (11) and partially overlaps with the capillary sheet (20). When the culturing slide (10) stands on a basin full of water, the capillary sheet (20) absorbs water and guides water over the guiding arc (122) to reach the gradual slop (11). Then, water travels over the entirely immersion sheet (22) to supply seeds on the gradual slop (11) by gravity attraction. Additionally, exceeded water slides along the gradual slop (11) to the basin to recycle.

### BACKGROUND OF THE INVENTION

1. Field of the Invention

The present invention relates to a self-watering breeding device, and more particularly to a self-watering breeding that has a simple structure and excellently watering efficiency for evenly breeding plants.

2. Description of Related Art

Small plants or vegetable sprouts are commonly bred in house with various types of containers filled with water or plant growing materials to culture pot plants or vegetables. However, breeding the plants is troublesome because breeders have to pay a lot of attention to water the plants. Therefore, several types of self-watering breeding devices are developed to resolve the breeders' troublesome matters.

With reference to FIGS. 6 and 7, a first conventional self-watering breeding device comprises a basin (80), an optional soaping plate (82), a breeding plate (84), an immersion sheet (86) and a cover (88).

The basin (80) is a rectangular box with four sides and a bottom and has an importing port (802) defined at one side of the basin (80). The optional soaping plate (82) is accommodated inside the basin (80) and has multiple leaking holes (not numbered) defined in a bottom face of the soaping plate (82) to drain out excess water to the bottom of the basin (80). The breeding plate (84) is mounted on the soaping plate (82) to support seeds and has a watering device (85) mounted on a center of the breeding plate (84) to attract the water upward. The water device (85) is consisted of a cubic base (not numbered) with two side cutouts and a wicking sheet (not numbered) attached on a top face of the base and extended downward via the two side cutouts of the base. The immersion sheet (86) is mounted on the breeding plate (84) to contact with the wicking sheet, so that water can be further absorbed by the immersion sheet (86) to spread all ospread all over the breeding plate (84). Lastly, the cover (88) is detachably mounted on the basin (80) to close the first conventional self-watering breeding device.

However, the first conventional self-watering breeding device has high product cost because it contains several elements. Additionally, the first conventional self-watering breeding device has poor watering efficiency because parts of the immersion sheet (86) away from the watering device (85) are hard to have enough water.

With reference to FIGS. 8 and 9, a second conventional self-watering breeding device comprises a support frame (90), multiple sack-like bags (92) and multiple loose flats (922).

The support frame (90) is in form of double shaped platforms arranged side-by-side and separated by a trough (94), wherein the platforms are sloped to the trough (94). Additionally, multiple ribs (902) are formed on tops of the platforms.

The multiple sack-like bags (92) are arranged on the platforms. Each sack-like bag (92) has a wrapping (not numbered) made of wicking material and a plant growth material (not numbered) filled inside the bag.

The multiple loose flaps (922) are individually attached to the sack-like bag (92). Each loose flap (922) is a part of a lower surface forming portion of the sack-like bag and extends downwardly from the bag into the trough (94) for immersion in a liquid, such as water, water-fertilizer mixture and the like. The liquid is continuously flowed by capillary action up the loose flap (922) and along wrapping for continuous dispersion into the filler material for feeding liquid to roots of plants.

Although the second conventional self-watering breeding device has a simpler structure than the first conventional one, the second conventional self-watering breeding device still has poor watering efficiency at distal edges of the sack-like bags (92) because only rear liquid attracted by capillary force can overcome the gravity force to reach the distal edges.

The present invention has arisen to mitigate or obviate the drawbacks of the conventional self-watering breeding devices.

### SUMMARY OF THE INVENTION

The main objective of the present invention is to provide a self-watering breeding device that has a simple structure.

The other objective of the present invention is to provide a self-watering breeding device that has an excellent watering efficiency to evenly spread liquid all over the device.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a self-watering breeding device in accordance with the present invention;

FIG. 2 is an enlarged cross-sectional side plane view of the self-watering breeding device in FIG. 1, wherein the self-watering breeding device is assembled;

FIG. 3 is an operational cross-sectional side plane view of the self-watering breeding device, wherein the self-watering breeding device is accommodated inside a hothouse;

FIG. 4 is a cross-sectional side plane view of another embodiment of a self-watering breeding device in accordance with the present invention;

FIG. 5 is a cross-sectional side plane view of a further embodiment of a self-watering breeding device in accordance with the present invention;

FIG. 6 is an exploded perspective view of a first conventional self-watering breeding device in accordance with the prior art;

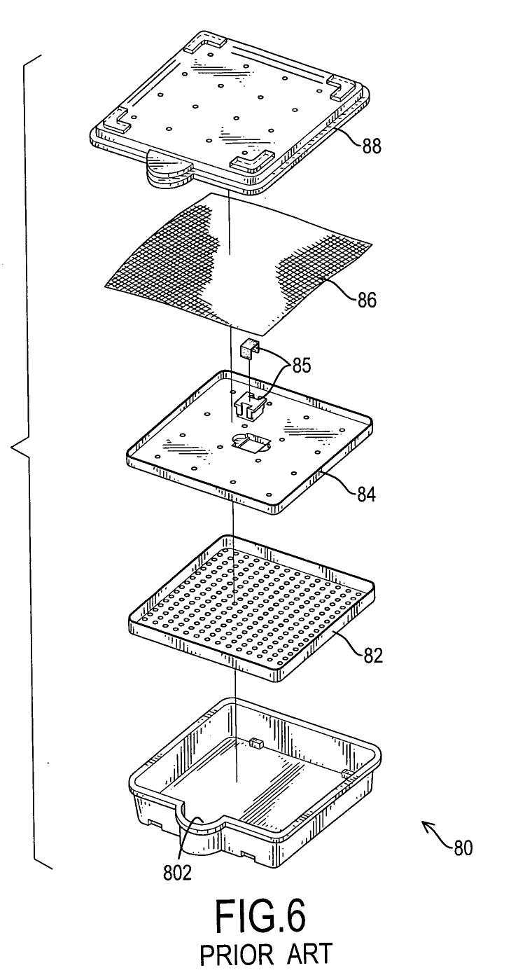

FIG. 7 is an enlarged cross-sectional side plane view of the first conventional self-watering breeding device in FIG. 6, wherein the first conventional self-watering breeding device is assembled;

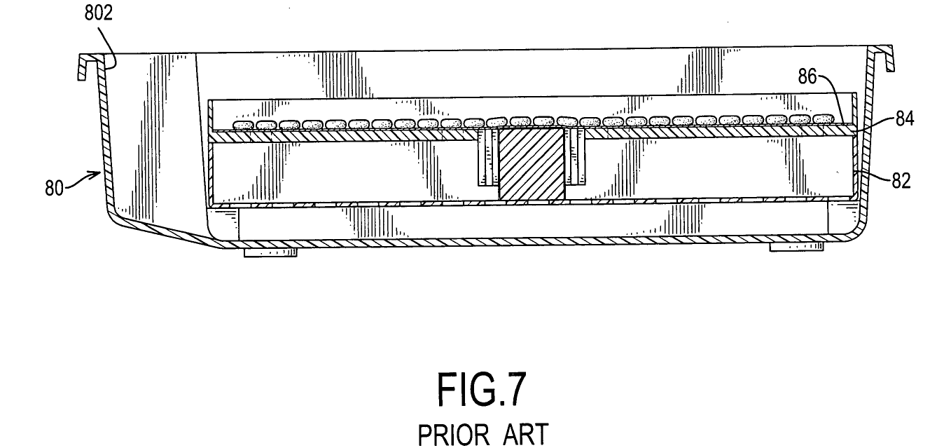

FIG. 8 is a perspective view of a second conventional self-watering breeding device in accordance with the prior art; and

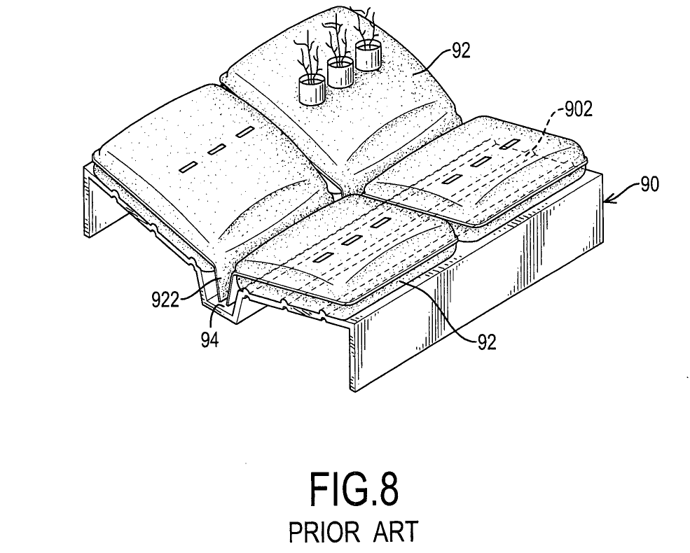

FIG. 9 is an enlarged cross-sectional side plane view of the second conventional self-watering breeding device in FIG. 8, wherein the second conventional self-watering breeding device is assembled.

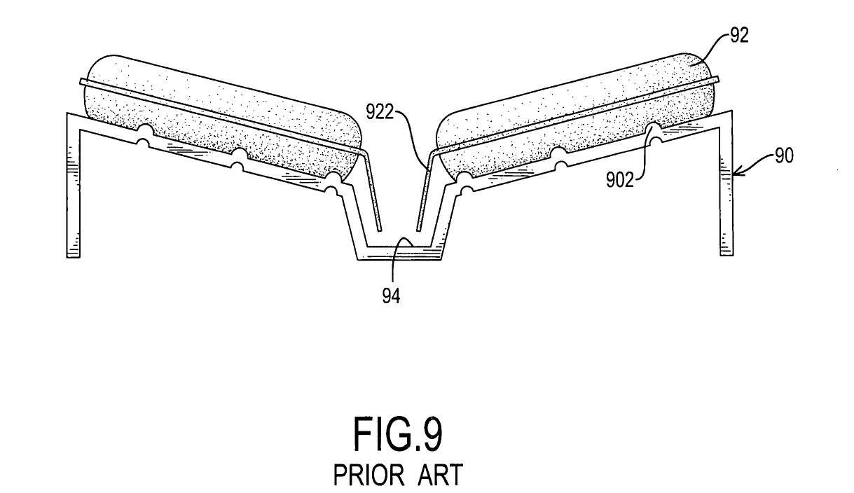

### DETAILED DESCRIPTION OF THE PREFERRED EMBODIMENT

A self-watering breeding device in accordance with the present invention comprises a culturing slide, a capillary sheet and an optional immersion sheet. The culturing slide has a gradual slop, a steep slop and a guiding arc connected between the gradual slop and the steep slop. The capillary sheet attaches on the steep slop and extends over the guiding arc. The immersion sheet attaches on the gradual slop and partially overlaps with the capillary sheet. When the culturing slide stands on a basin full of water, the capillary sheet absorbs water and guides water over the guiding arc to reach the gradual slop. Then, water travels over the entirely immersion sheet to supply seeds on the gradual slop by gravity attraction. Additionally, excess water slides along the gradual slop to the basin to recycle again.

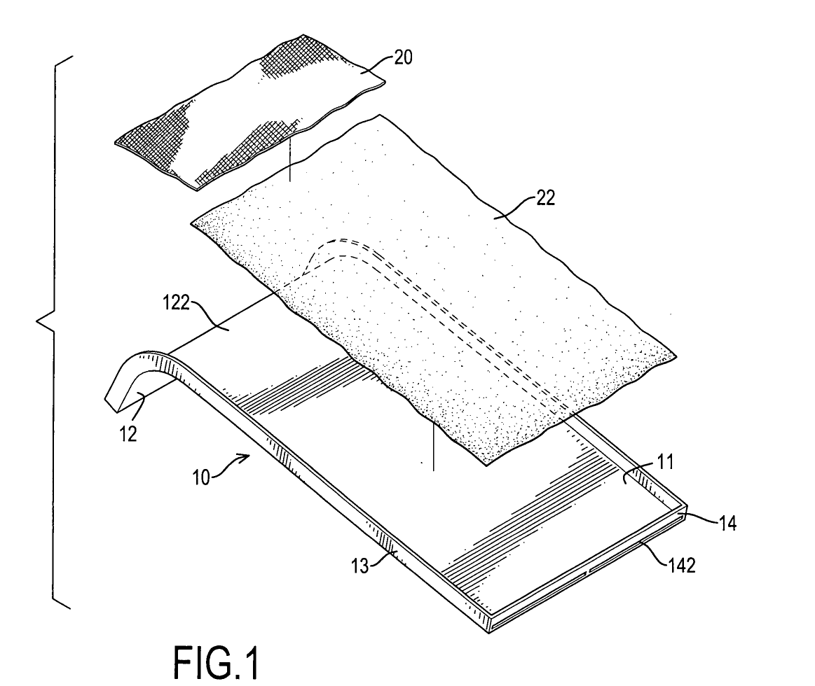

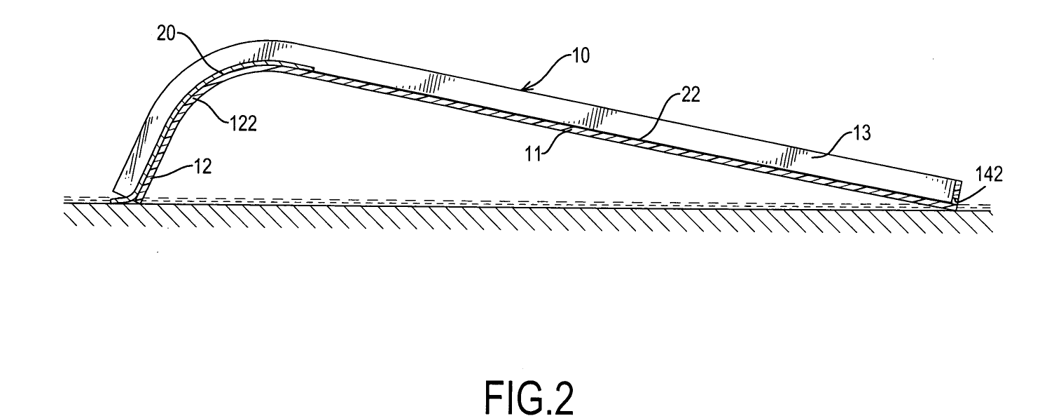

With reference to FIGS. 1 and 2, a first preferred embodiment of self-watering breeding device in accordance with the present invention comprises a culturing slide (10), a capillary sheet (20) and an immersion sheet (22).

The culturing slide (10) is a bridge with two sides and two ends and is composed a gradual slop (11), a steep slop (12) and a guiding arc (122) integrally connected between the gradual slop (11) and the steep slop (12). The culturing slide (10) further has two side boards (13) erectly formed at two sides of bridge and a bottom board (14) formed at the end at the steep slop (12). Additionally, two elongated holes (142) are defined in the bottom board (14) to drain excess water.

The capillary sheet (20) is placed on the steep slop (12) to absorb water upward to the gradual slop (11). Preferably, the capillary sheet (20) and has a width same as that of the culturing bridge and a length longer than that of the steep slop (12). Therefore, the capillary sheet (20) enables to extend from the end of the steep slop (12) to exceed the guiding arc (122) to the gradual slop (11). In order to absorb water efficiently, the capillary sheet (20) is made of absorbent materials selected from the group of cotton cloth, non-woven cloth, sponge and paper. Preferably, the capillary sheet (20) is made of cotton cloth.

The immersion sheet (22) is placed on the gradual slop (11) to cover the entire gradual slop (11). A part of the immersion sheet (22) overlaps the exceeded capillary sheet (20) so that water can be further conducted to the gradual slop (11). The immersion sheet (22) is made of absorbent material 8 selected from the group of cotton cloth, non-woven cloth, sponge and paper. Preferably, the capillary sheet (20) is made of cotton cloth. Preferably, the selected from the group of cotton cloth, non-woven cloth, sponge and paper.

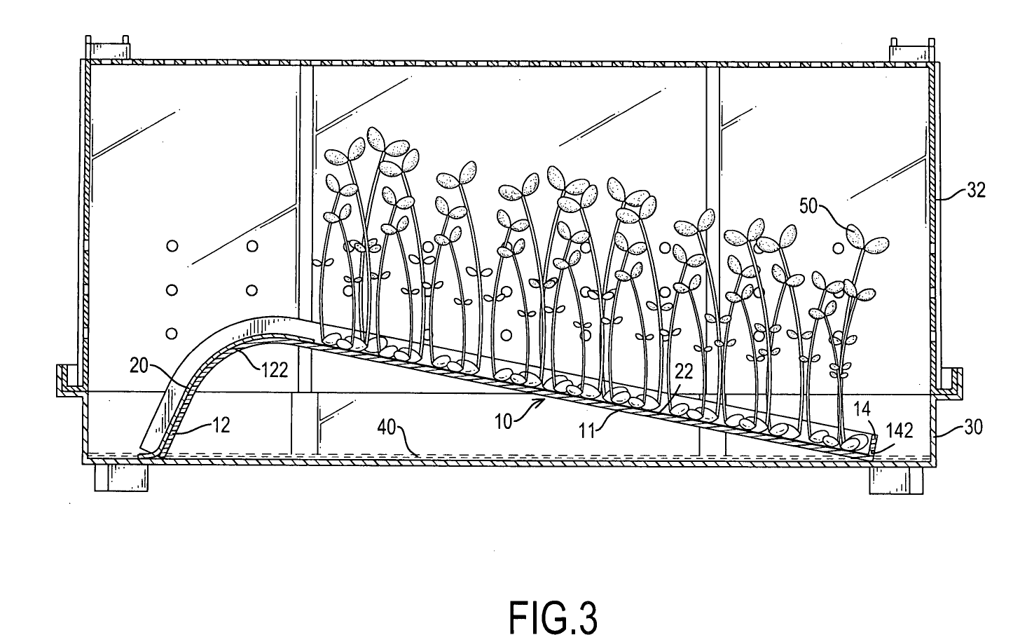

With further reference to FIG. 3, when the self-watering breeding device is in use, the culturing slide (10) stands on a basin (30) full of water (40) or fertile liquids and multiple seeds are evenly arranged on the immersion sheet (22). The capillary sheet (20) is partially immerged in the water to absorb water to guide water over the guiding arc (122) to reach the gradual slop (11). Then, the water automatically travels all over the entirely immersion sheet (22) to water seeds and sprouts on the gradual slop (11) by gravity attraction. Excessive water slides along the gradual slop (11) back to the basin (30) to recycle. Additionally, a transparent housing (32) mounts on the basin (30) to avoid the water evaporating quickly.

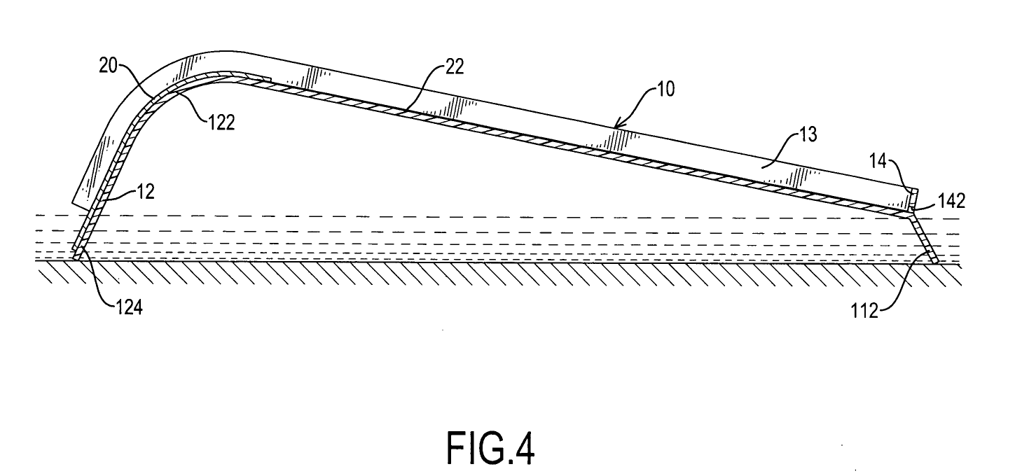

With reference to FIG. 4, a second preferred embodiment of the self-watering breeding device in accordance with the present invention has the same structure with the first embodiment except multiple extending feet (112, 124). Two extending feet (112, 124) are respectively formed at the two ends of the culturing slide (10). Thereby, the culturing slide (10) is raised to allow more water stored inside the basin. Therefore, breeders do not have to add water so often.

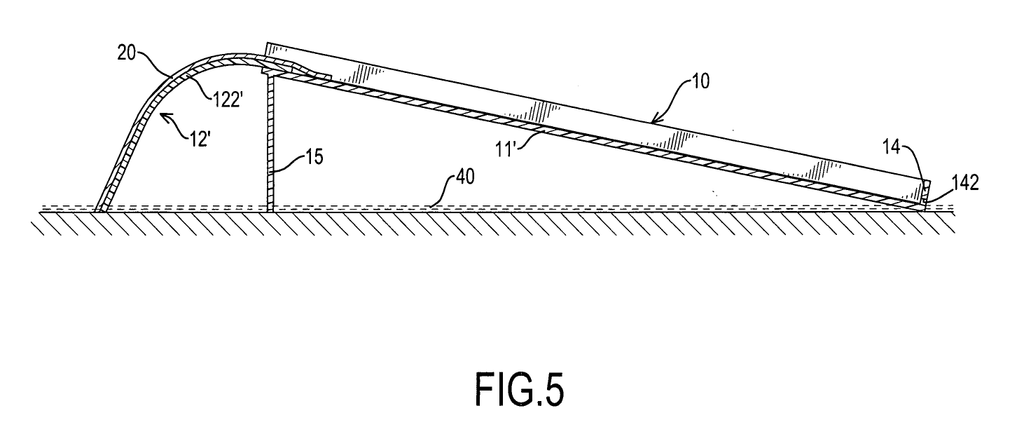

With reference to FIG. 5, a third embodiment of the self-watering breeding in accordance with the present invention has the same design concept with the first embodiment except the steep slop (12′) with the guiding arc (122′) is separated from the gradual slope (11′). The gradual slop (11′) further has a supporting foot (15) attached under a distal end of the gradual slop (11′) close to the steep slop (12′) to make the gradual slop (11′) erect.

Acc above description, the self-watering breeding device of the present invention has the following advantages:
1. Structure of the self-watering breeding device is quite simple because the device only contains the culturing slide (10) and two absorbent sheets (20, 22). Therefore, manufacturing cost and product cost is extremely low in comparison with the two conventional self-watering breeding devices.
2. All seeds on the gradual slop have enough water for immersion because the water automatically flows down along the gradual slop by gravity to pass the gradual slop all over.

Although the invention has been explained in relation to multiple preferred embodiments, many other possible modifications and variations can be made without departing from the spirit and scope of the invention as hereinafter claimed.

1. A self-watering breeding device comprising:
a culturing slide (10) being a bridge with two sides and two ends and having
a gradual slop (11) with one end of the bridge;
a steep slop (12) with the other end of the bridge; and
a guiding arc (122) connected between the gradual slop (11) and the steep slop (12);
a capillary sheet (20) placed on the steep slop (12) and extending from the end of the steep slop (12) over the guiding arc (122) to the gradual slop (11);
an immersion sheet (22) placed on the gradual slop (11) to cover the entire gradual slop (11) and partially overlapping with the capillary sheet (20).

2. The self-watering breeding device as claimed in claim 1, wherein the guiding arc (122) is integrally connected between the steep slop (12) and the gradual slop (11).

3. The self-watering breeding device as claimed in claim 2, wherein the culturing slide (10) further has
two side boards (13) erectly formed at two sides of bridge;
a bottom board (14) formed at the end at the steep slop (12); and
two elongated holes (142) defined in the bottom board (14) to drain water.

4. The self-watering breeding device as claimed in claim 1, wherein the culturing slide (10) further has two extending feet (112, 124) respectively formed at the two ends of the culturing slide (10) to raise the culturing slide (10).

5. The self-watering breeding device as claimed in claim 3, wherein the culturing slide (10) further has two extending feet (112, 124) respectively formed at the two ends of the culturing slide (10) to raise the culturing slide (10).

6. The self-watering breeding device as claimed in claim 1, wherein the steep slop (12′) is separated from the gradual slope (11′) and has the guiding arc (122′) integrally formed with the steep slop (12′);
wherein the gradual slop (11′) further has a supporting foot (15) attached under the gradual slop (11′) to make the gradual slop (11′) erect.
